(19) United States
(12) Patent Application Publication
(10) Pub. No.: US 2023/0037523 A1
(43) Pub. Date: Feb. 9, 2023

(54) ELECTRONIC FRY PAN AND BATTERY POWER SUPPLY

(71) Applicant: Murray Ruben, Santa Barbara, CA (US)

(72) Inventor: Murray Ruben, Santa Barbara, CA (US)

(21) Appl. No.: 17/881,951

(22) Filed: Aug. 5, 2022

Related U.S. Application Data
(60) Provisional application No. 63/230,372, filed on Aug. 6, 2021.

(51) Int. Cl. A47J 37/10

(52) U.S. Cl. CPC A47J 37/105; A47J 37/108

(57) ABSTRACT

An electronic fry pan incorporates a pan base and a pan received concentrically in the pan base. A foil heater assembly is mounted to the bottom of the pan and a heater control PCB carried in the pan base is connected to the foil heater. A battery assembly has a cylindrical shell carrying a battery pack. A power controller carried in the second outer shell is connected to the battery pack. A connector carriage is engaged between the battery assembly and cylindrical shell, extending through the shell of the battery assembly and received in the pan base aligned proximate a bottom surface of the pan base whereby the bottom surfaces of the pan base and the cylindrical shell are in planar alignment. A first contact set of a connector is connected to the heater control PCB. A sec and contact is connected to the power controller.

### REFERENCE TO RELATED APPLICATIONS

This application claims the priority of U.S. provisional application Ser. No. 63/230,372 filed on Aug. 6, 2021 entitled ELECTRONIC FRY PAN AND BATTERY POWER SUPPLY having a common applicant with the current application, the disclosure of which is incorporated herein by reference. This application is also co-pending with U.S. application Ser. No. 16/576,383 filed on Sep. 19, 2019 entitled ELECTRONIC STOVE AND UNIVERSAL POWER SUPPLY, the disclosure of which is incorporated herein by reference.

### BACKGROUND

### Field

This invention relates generally to portable cooking systems and more particularly to an integrated frying pan, heating element and battery assembly.

### Description of the Related Art

Camping or backpacking stoves and fry pans are highly useful for remote operation when other cooking facilities are not available. Propane or butane heater systems are available which provide adequate heat to boil water or generally heat meals with high liquid content. However, open flames are always potentially hazardous.

It is therefore desirable to provide a device which provides capability for heating meals which is easily portable but does not employ a flame heater.

### SUMMARY

The embodiments disclosed herein overcome the shortcomings of the prior art by providing an electronic frying pan (E-Pan) incorporating a pan and heater system (PHA) having a pan base with a metal pan concentrically received in the pan base. A foil heater assembly is adhered to a bottom of the metal pan. A heater control printed circuit board (PCB) is carried in the pan base and operationally connected to the foil heater. A battery assembly has a substantially cylindrical shell and a battery pack carried within the cylindrical shell. A power controller printed circuit board is carried in the cylindrical shell and operationally connected to the battery pack. A connector carriage is extendable from the battery assembly proximate a bottom surface of the cylindrical shell and adapted to be engaged between the battery assembly and the PHA in an operating mode, the connector carriage removably extending through an aperture in the cylindrical shell of the battery assembly and received through a power port in the pan base. The power port is proximate a bottom surface of the pan base and aligned with the aperture whereby the bottom surface of the pan base and bottom surface of the cylindrical shell are in planar alignment. A first contact set of a connector is carried by and operationally connected to the heater control PCB. A second contact set of the connector is carried by the connector carriage and operationally connected to the power controller printed circuit board.

### BRIEF DESCRIPTION OF THE DRAWINGS

These and other features and advantages of the present invention will be better understood by reference to the following detailed description of exemplary embodiments when considered in connection with the accompanying drawings wherein:

FIGs. 1A -1D are pictorial representations of the E-Pan in the operating mode;

FIG. 2 is a pictorial view of the E-Pan in the storage mode;

FIG. 3 is an exploded view showing internal components of the pan and heating assembly (PHA);

FIG. 4 is a side section view of the PHA;

FIG. 5 is a detailed pictorial section view of the battery assembly;

FIG. 6 is a detailed side section view of the connection elements of the E-Pan in the operating mode;

FIGS. 7A-7D are detail representations of the connector carriage in various positions;

FIG. 7E is a detail representation of the connector carriage with the pinion handle in the extended unlocked position;

FIG. 8 is a partial pictorial view of the pan base showing the heater control PCB as installed in the pan base cavity;

FIG. 9 is a block diagram of the power controller printed circuit board (PCPCB) elements;

FIGS. 10-1-10-3 are a flow chart of operation of the PCPCB;

FIG. 11 is a block diagram of the heater control PCB;

FIGS. 12-1-12-3 are a flow chart of the operation of the heater control PCB; and,

FIG. 13 is a schematic of an NFET switch circuit for the battery control system.

### DETAILED DESCRIPTION

Implementations shown in the drawings and described herein provide a rectangular battery powered electronic frying pan (“E-Pan”) with an integrated pan and heating assembly and a battery assembly having a substantially cylindrical form factor allowing storage in a water bottle holder in a backpack and in a second operating mode with the battery system laterally engaged to the liquid container for increased standing stability while providing power to the heating system.

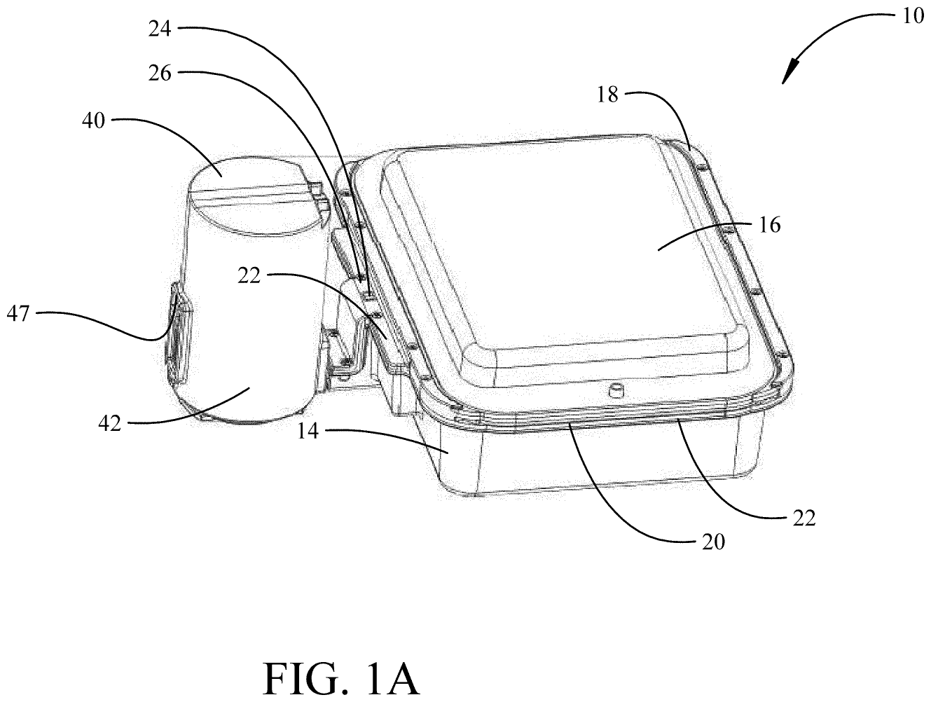

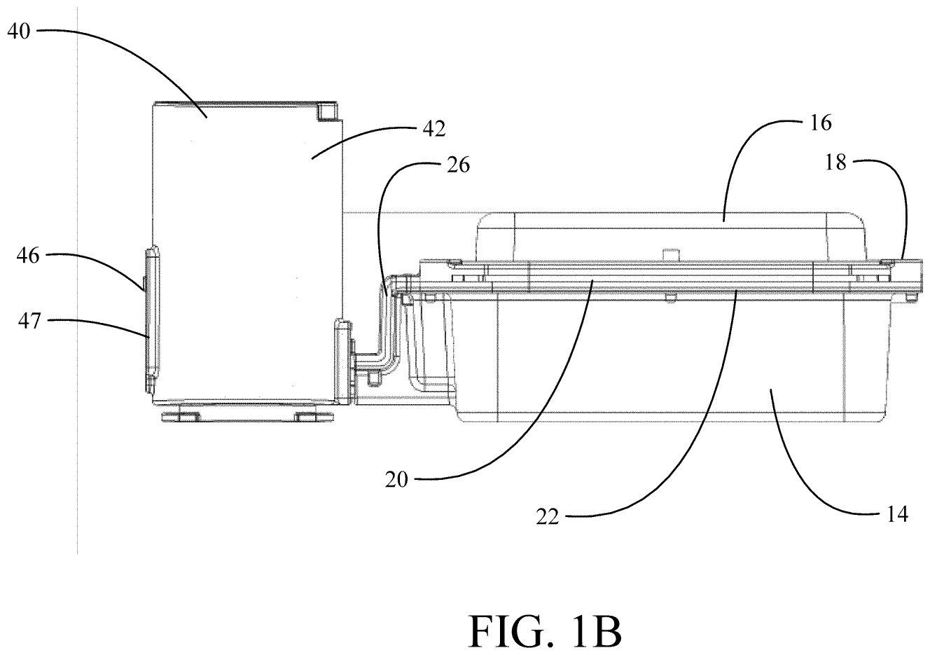

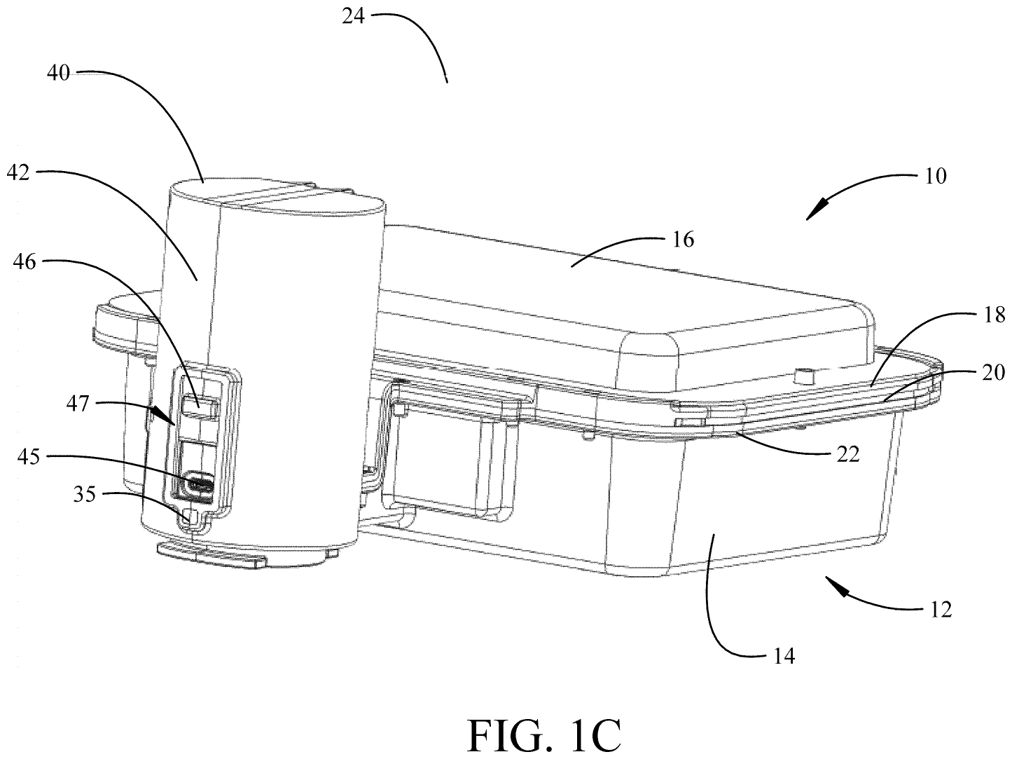

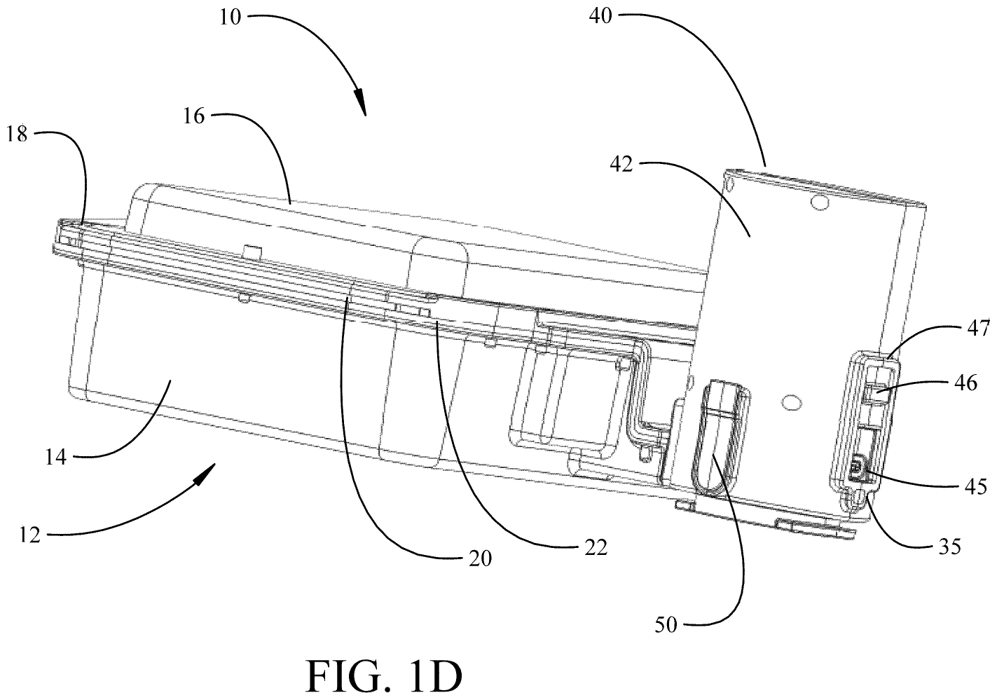

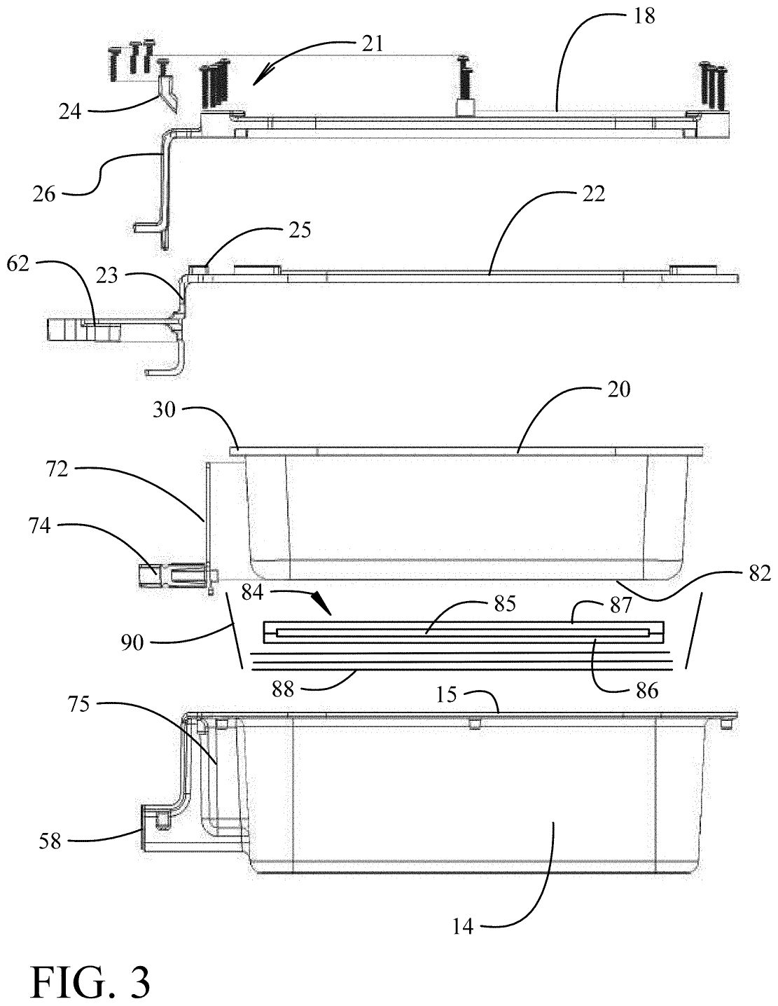

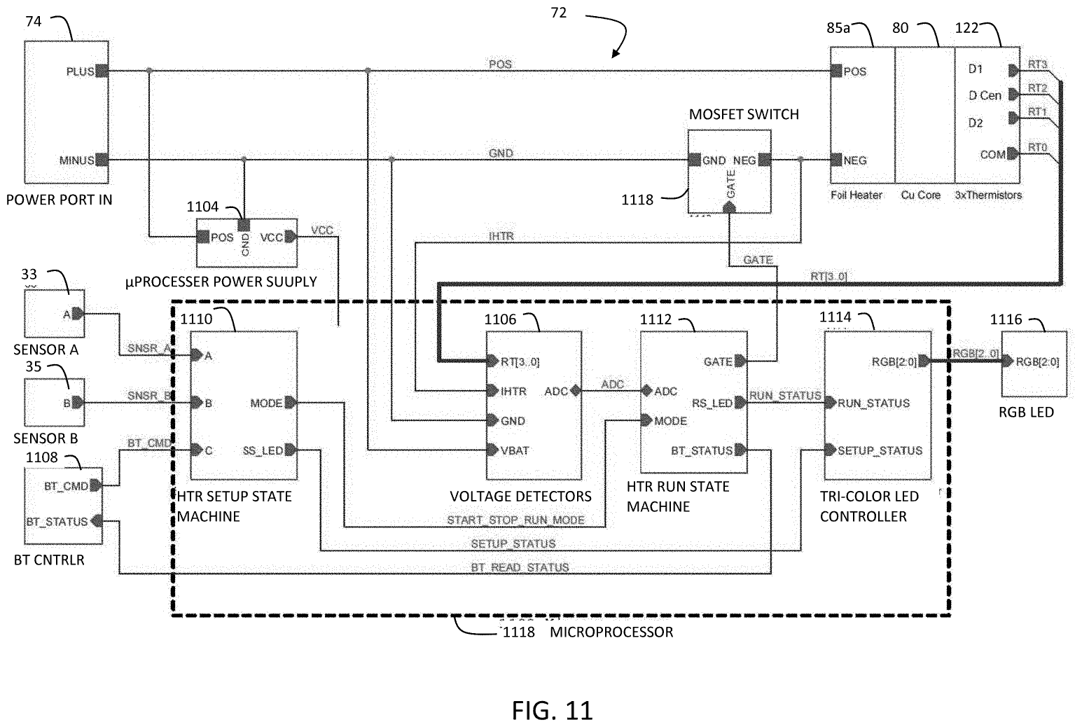

Referring to the drawings, FIGS. 1A-1D show an E-Pan 10 in the operating mode. A pan and heating assembly 12 (PHA) has a pan base 14 with a cover 16. The cover 16 is received on a top frame 18 which engages a pan 20 and a pan gasket 22 to the pan base 14, as will be described in greater detail subsequently. A bulged plenum 75 incorporates a power port 58 in the pan base 14, as will be described in greater detail subsequently. An LED indicator 24 is held snugly within a raised well 25 (seen in FIG. 3) extruded from the pan gasket 22 which is then located inside an extension 26 of the top frame 18 as seen in FIG. 1A. A tri color LED 1116 (as described subsequently with respect to FIG. 11) is employed in the LED indicator 24 and used to convey information regarding the heater settings and heater status by varying color and flash rates of the LED.

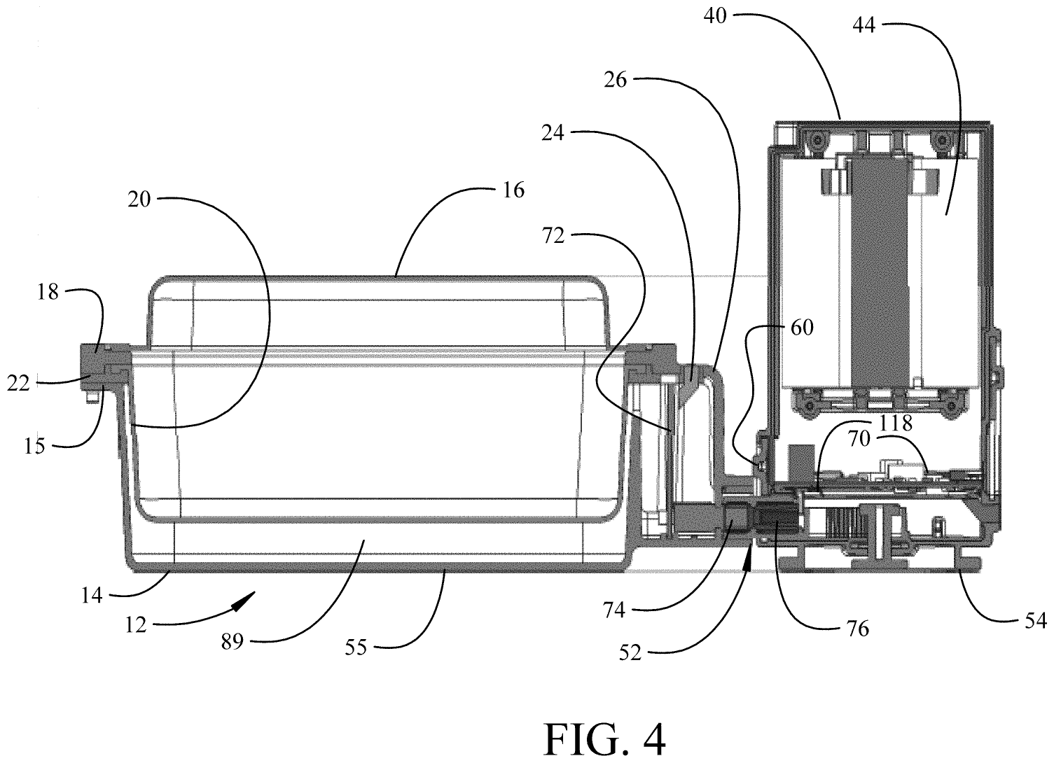

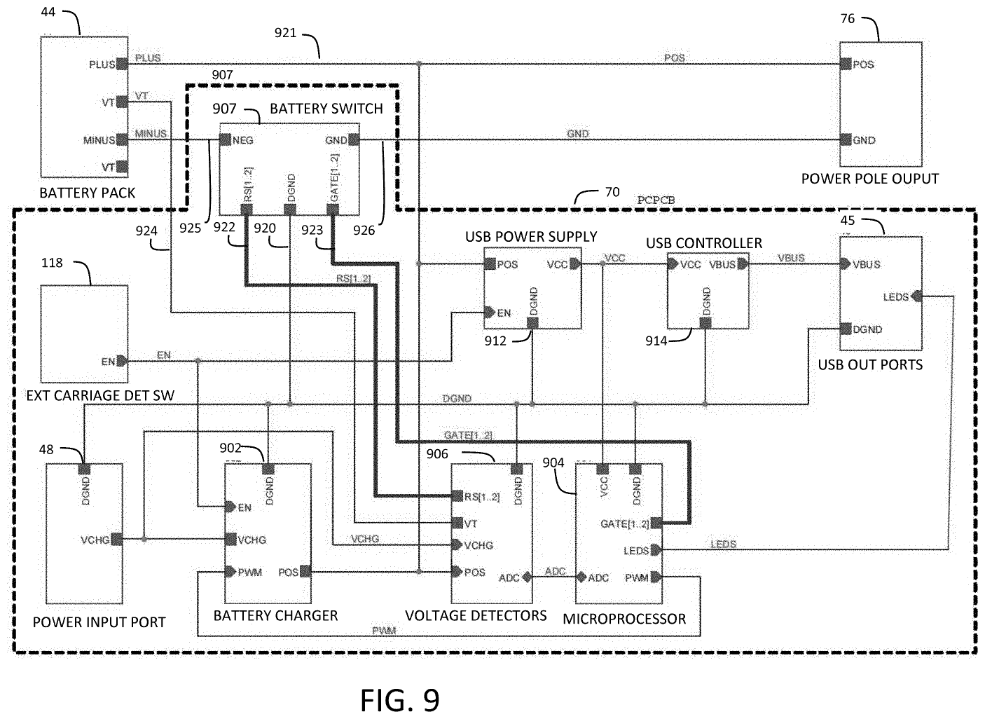

A battery assembly 40 has a cylindrical shell 42. The battery assembly 40 includes a battery pack 44 (shown in FIGS. 4, 5, 6 and 7E) and has USB power output ports 45 behind an openable cover 46 on a blister 47 on the cylindrical shell 42 as seen in FIG. 1C. A universal charger power input jack 48 (described with regard to FIG. 9 below) is housed behind a second openable cover 50 as seen in FIG. 1D. In the exemplary implementations an LED lens 35 is engaged in a pocket within the raised section of the blister 47. An LED is carried behind LED lens 35 for providing battery status information. The LED will gradually change from a steady pure Green to pure Red, transitioning thru the lime green, yellow, near orange, colors as the battery voltage (surrogate for state of charge) declines. The LED is steady red when the battery is no longer capable of supporting a load, and alternately flashes Red with the battery state of charge color when one of several error conditions are detected while it automatically times out a restart event. It flashes green with the state of charge color when a charger is connected to the charger input port and the battery is charging. The flashing stops once the battery is fully charged. The error conditions which may be reflected by the LED are overheating battery control board, overheating battery cells, overcharging voltage or current (above maximum cell voltage or maximum charge rate), below minimum battery cell temperature, overloaded battery output current (the Anderson carriage connection) (includes short circuit load). All these protections are related to the battery protection circuit on the battery power control PCB (PCPCB), and its associated firmware.

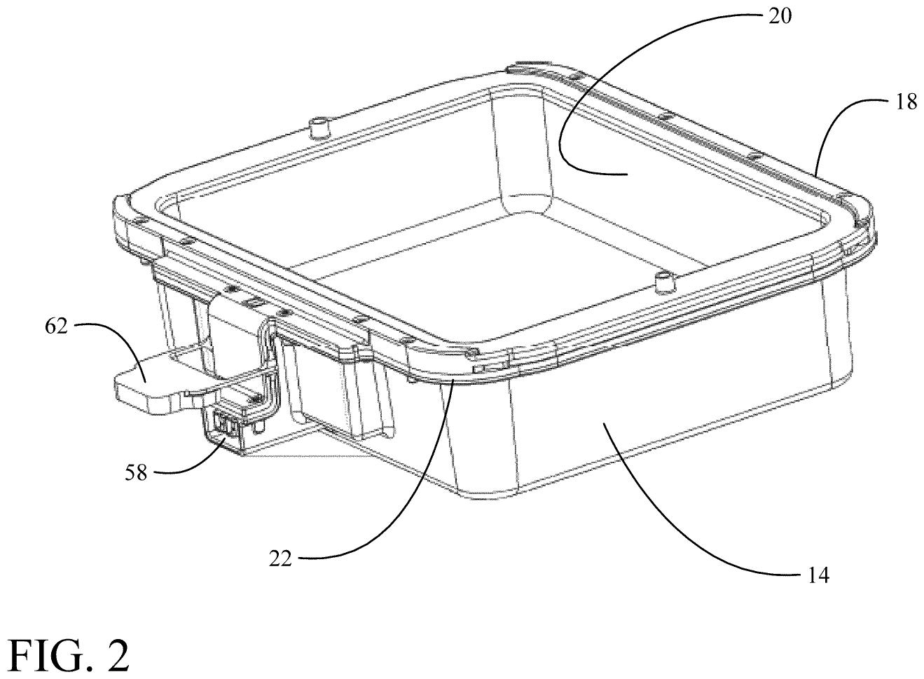

The battery assembly 40 is removable from PHA 12 for independent unit storage as shown in FIG. 2 and laterally engages the pan base 14 to place the E-Pan 10 in the operating mode seen in FIGS. 1A-1D, as will be described in greater detail subsequently. Details of the PHA 12 are shown in the exploded view of FIG. 3. In the example implementation of the PHA 12 the pan 20 is a suitable metal alloy having a solid bottom 82 less than 1.6 mm thick. At least one multilayer heater assembly 84 employs a 3 ohm, 300 W etched layer 85 mounted on a silicon rubber substrate 86 with a silicon rubber top layer 87 laminated over the foil layer (thicknesses exaggerated in the drawings for clarity) and sealed to the substrate making the heater less capable of bending but increasing the max temp from 125C to 200C. The heater is attached to the bottom of the pan 20 using a high temperature 3M adhesive and thermistors, to be described subsequently, are spaced evenly across the exposed side of the heater assembly. For the exemplary implementation, one thermistor is located at a first end of a diagonal of the heater assembly, a second at the center of the diagonal and a third at the second end of the diagonal. Alternative implementations for larger cooking capacity will use two side by side 300 W heater assemblies 84 and two batteries to expand the pan size to 8″×12″ size, where each 8″×6″ side can be independently controlled to provide a family sized solution. In that implementation, two power ports are incorporated side by side at ends of the bulged plenum 75 in the pan base 14. As an example, two heater foils would be mounted with their 8 inch edges abutting, forming an 8″ by 12″ base area. The bulged plenum 75 for the heater control PCB 72 would then be located between the two power ports instead of symmetrically located around the single power port in the first implementation. The heater control PCB is substantially identical to the single heater implementation except it will house two heater control FETs and require an additional set of thermistors and FET gate control signals, all of which would be multiplexed off the existing control signals. A mini pan implementation will shrink the heater and pan to 6″×6″ size with a 220 W heater to provide a very compact and portable one person cooking solution.

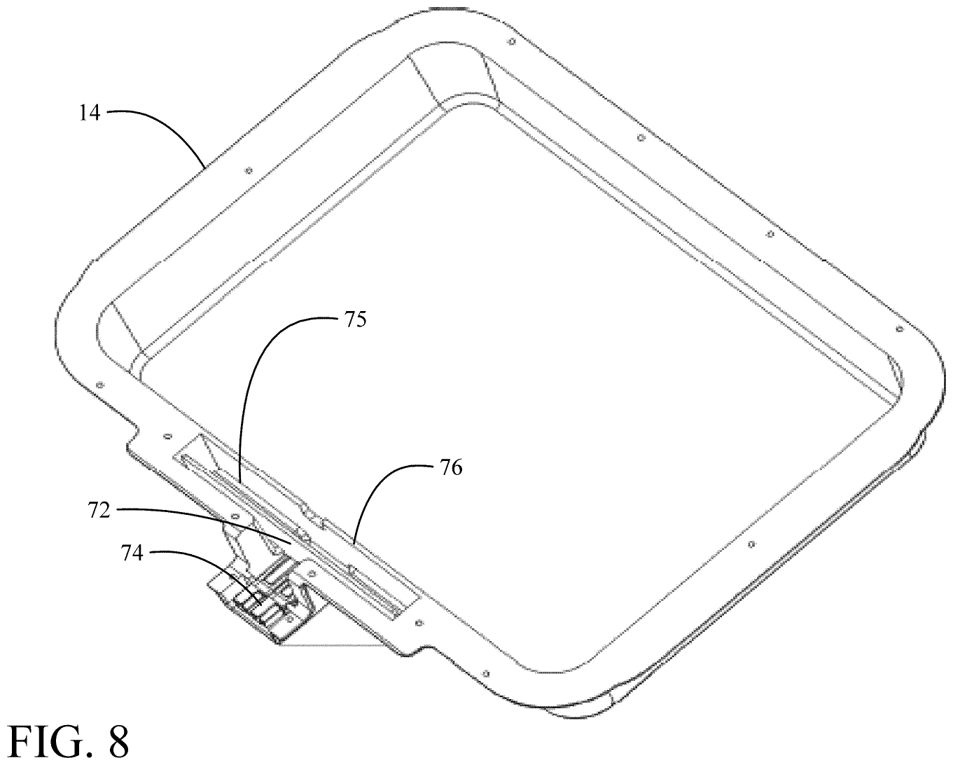

To assemble the PHA 12, a heater control PCB 72 with an attached connector 74 is placed in the bulged plenum 75 in the pan base 14 (as seen in FIG. 8). The gasket 22 is placed upon a top flange 15 of the pan base 14. The pan 20, with heater attached, is then concentrically received with the pan base 14 with a plurality of layers 88 of 2 mm ceramic paper inserted in the cavity 89 (seen in FIG. 4) between the pan 20 and pan base 14 and at least one layer 90 of 2 mm ceramic paper between all four walls of the pan and pan base. The top frame 18 is then placed over the pan and gasket. The top frame 18 is then screwed down into the top flange 15 using a plurality of screws 21 to engage a rim 30 of the pan against the gasket 22 to form a watertight seal and provide a cover 17 for the plenum 75. Additional screws may be employed to clamp an extension 23 of the gasket 22 and the extension 26 of the top frame 18 to the pan base 14. The rubber gasket 22 also has a captive power port plug 62 that can then flexibly engaged over a power port 58 to seal that opening.

The gasket 22 is a single molded element. The cap 62 is molded with the two thin connecting arms that allow it to be properly fitted over the power port opening, basically at right angles to its rest (molded) starting position and folds up when the battery connector is inserted into the power port, described in greater detail subsequently. The gasket 22 is molded to accept the pan 22 into an interference fit and to allow the two side flanges (with holes) to pass over the gasket. Bosses 27 molded into the pan base 14 pass through holes in the rim 30 of the pan 20 and top frame side flanges, allowing two screws to clamp the top frame down hard upon the rim 30 of the pan 20 at the center of the flanges. The other screws all serve to clamp the top frame 18 down on the top of the gasket 22, causing the elastic rubber to compress and fill all voids between the bottom surface of the pan rim and the top flange 15 of the pan base 14. This provides a watertight seal, allowing the pan to be easily cleaned without concern for water penetrating into the interior heater, insulation, and control board space. Other places where the gasket shape is used to achieve this water seal include the raised well 25 for the LED and the already mentioned power port cap 62. The objective is to seal everything well enough that the pan can be immersed in water (an anticipated consequence when cleaning the pan).

As seen in FIG. 8, the heater control PCB 72 mounts vertically into plenum 75 just behind the power port opening. That plenum 75 is isolated from the main pan heating area by a wall 76 substantially sealing off the pan area. The heater control PCB 72 mounts very close to the exterior wall of the pan base 14 and contains two equal capacitive sensors 33, 35 (seen in FIG. 11), described in greater detail subsequently, evenly spaced apart on the right side of the bulged plenum 75. A radio transmitter is located in a similar position at the end of the left side of the plenum, parallel to the outer shell wall.

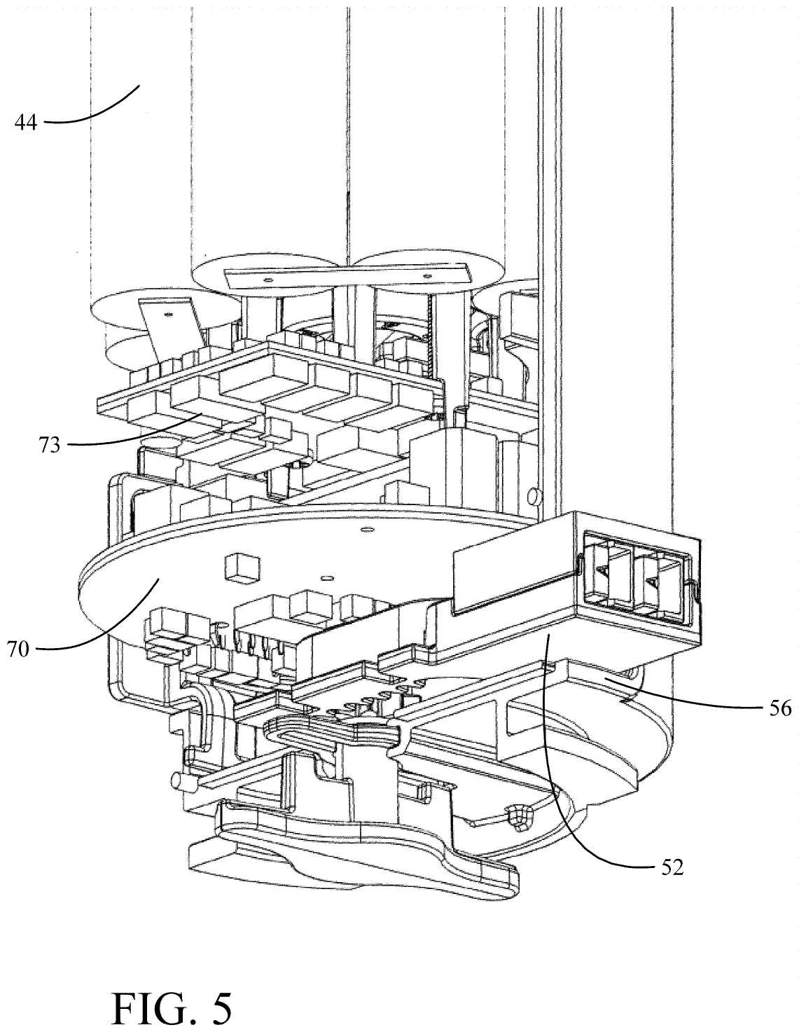

As seen in FIG. 4, a connector carriage 52, extendable from the battery assembly 40 proximate the bottom 54 of the battery assembly 40, is engaged between the battery assembly 40 and the PHA 12. The connector carriage 52 extends through an aperture 56 (seen in FIG. 5) in the cylindrical shell 42 of the battery assembly 40 and is received through the power port 58 in pan base 14 of the PHA 12. In the operating mode, a bottom surface 54 of the battery assembly 40 and a bottom surface 55 of the pan base 14 are in planer alignment to allow the E-Pan to stand on a flat surface. The aperture 56 and power port 58 are closed with door 60 and plug 62, respectively, in the non-operating mode. The connector carriage 52 firmly engages the battery assembly 40 and the PHA 12 in the operating mode. In this configuration, the battery assembly 40 and PHA mutually stabilize one another allowing the E-Pan 10 to stand with high stability without additional support in the operating mode.

As seen in FIGS. 4 and 5, the battery assembly 40 incorporates a universal power controller printed circuit board (PCPCB) 70 interconnected to the battery pack 44 and the universal power input jack 48. The PCPCB 70 is connected through the connector carriage 52 to a heater control PCB 72 in the PHA 12. For the exemplary implementation, an Anderson connector having a first contact set 74 carried on the heater control PCB and the second contact set 76 carried in the connector carriage 52 provides both electrical power and mechanical interlock.

In the exemplary embodiment, the battery cells in battery pack 44 are arranged around a pair of spacers that locate eight cells on a circular pattern with a ninth cell in the center. This produces nominal 34V output under load in a very compact, circular shape. The spacers have access holes that allow the cell wires to pass thru them to be attached to the PCPCB 70.

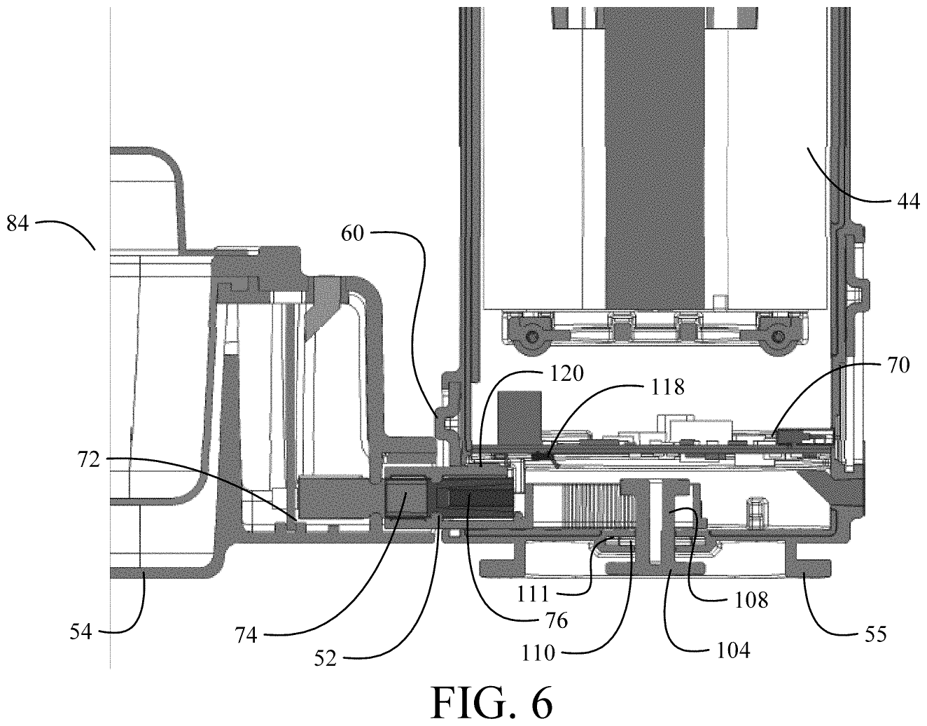

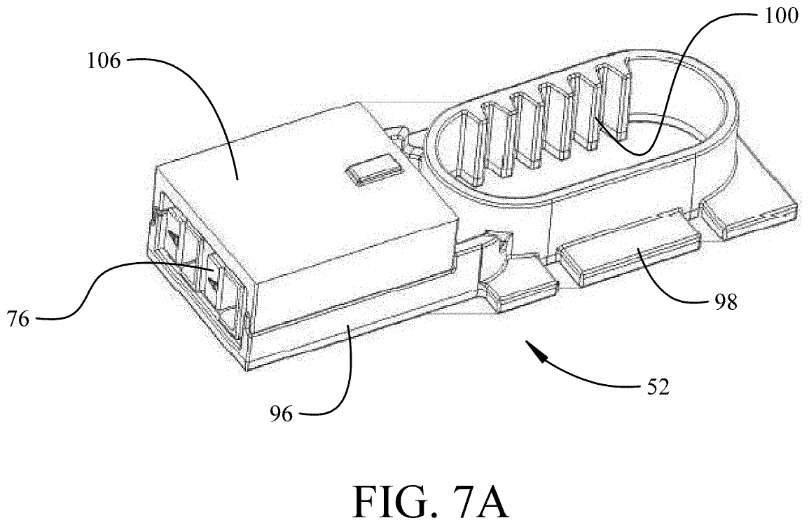

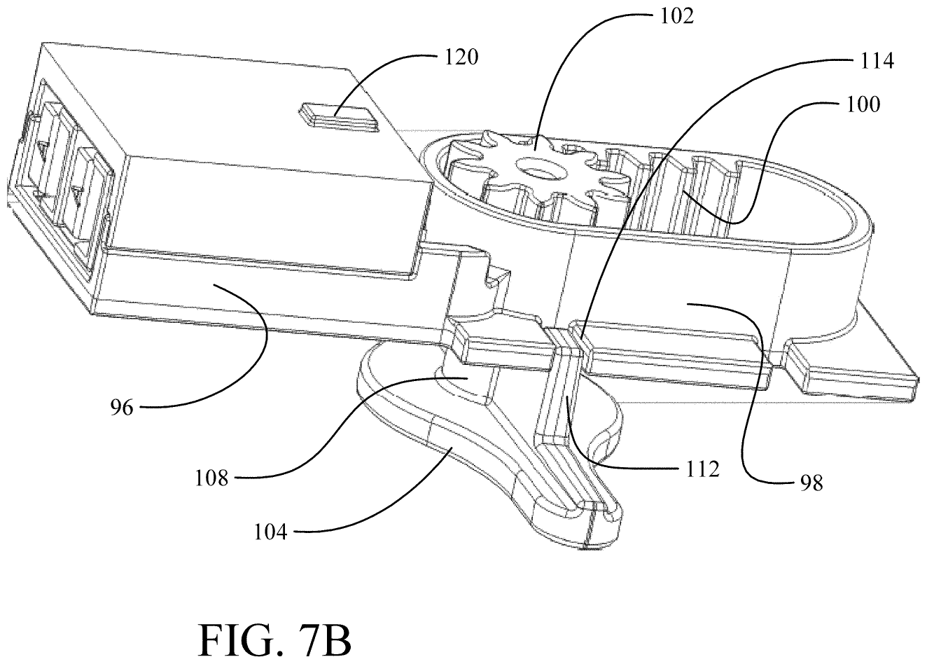

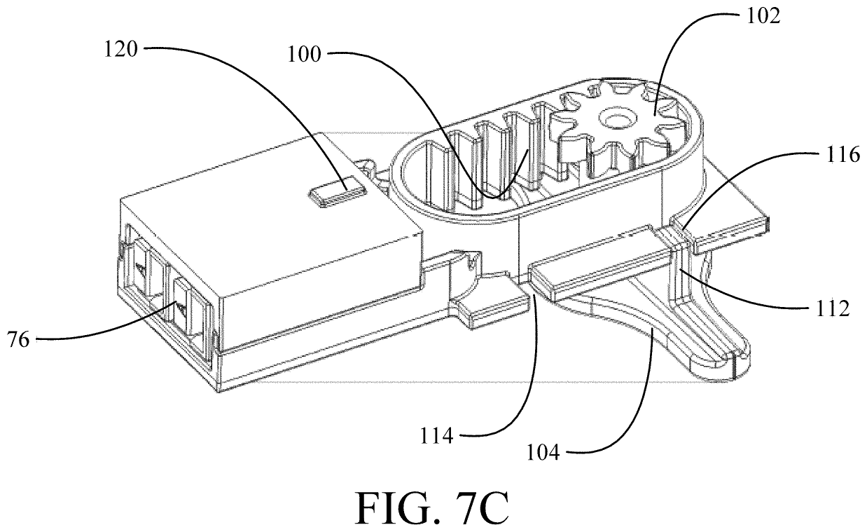

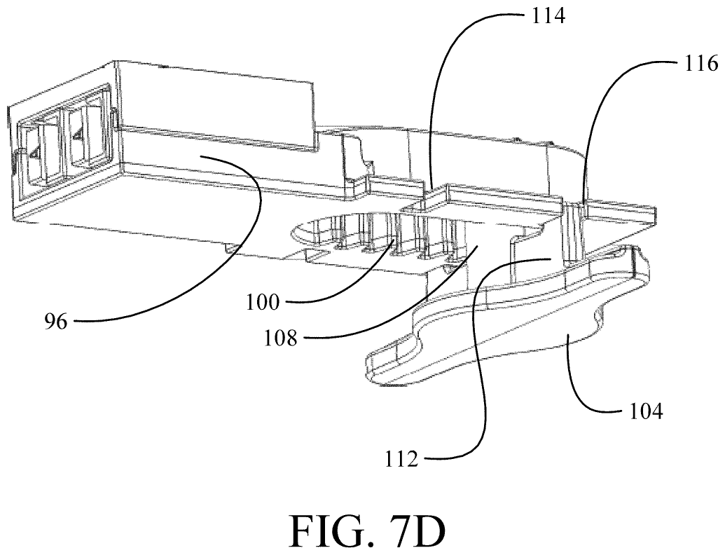

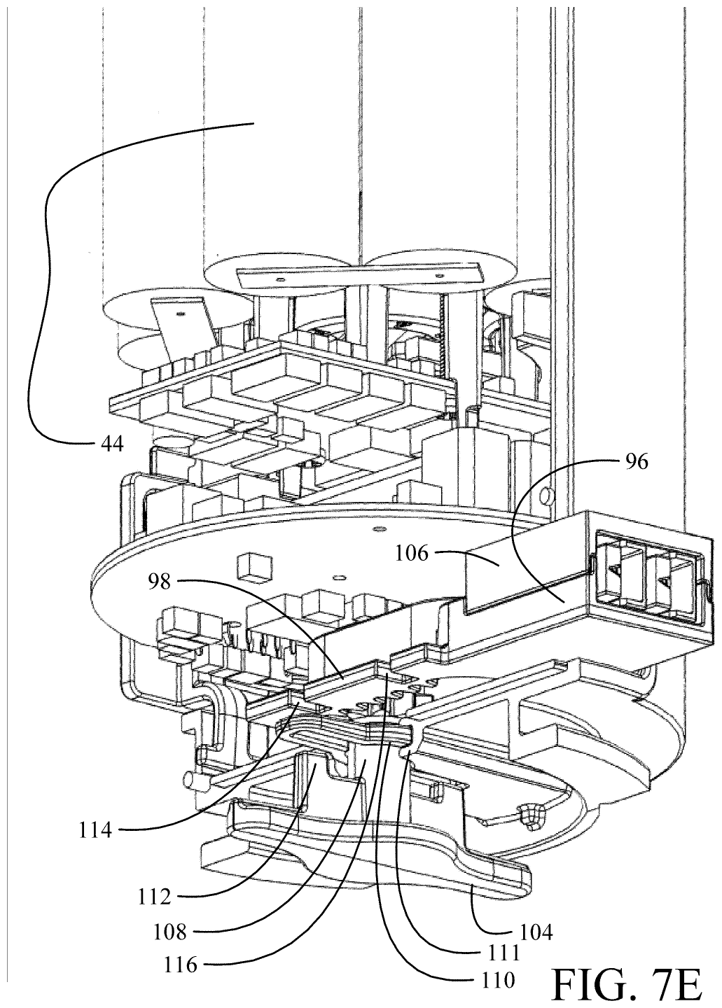

As seen in FIG. 6 and shown in detail in FIGS. 7A-7D, the connector carriage 52 has a connector carrier 96 which is attached to a translation body 98. The translation body 98 incorporates a rack 100 which is operatively engaged by a pinion 102. A rotating handle 104 extends from the pinion 102. A carriage top cover 106 secures the first contact set 76 of the connector to the connector carrier 96. The rotating handle 104 has a shaft 108 translatably carried in a pinion gasket 110 received in a collar 111 in the second cylindrical shell 42. The shaft 108 translates axially in the pinion gasket 110 between a first engaged position and a second locked position. In the locked position for the non-operating mode with the connector carriage 52 retracted (seen for example in FIG. 7B) tabs 112 on the handle 104 are received in retracted lock slots 114 in the translation body 98. In this position the connector carriage is locked in the retracted position and the handle 104 is restrained from rotation. The handle 104 is axially translated outward through pinion gasket 110 to withdraw the tabs 112 from the retracted lock slots 114 as shown in FIG. 7E allowing rotation of handle 104 and pinion 102 to drive the rack 100 to extend the connector carriage 52. Upon reaching the extended position as shown in FIGS. 7C and 7D, the handle 104 is axially translated inward engaging tabs 112 in extended lock slots 116 thereby locking the connector carriage 52 in the extended position to allow interconnection between the battery assembly 40 and PHA 12 for the operating mode. The handle 104, handle shaft 108 and pinion gear 102 are configured such that, when the handle is fully pulled outwards, the locking tabs are beyond the recess in the bottom of the battery shell, allowing the handle to then freely rotate between the alternate locking positions. The pinion gear is larger than the shaft opening and prevents the handle from being pulled all the way out. Furthermore, the height of the pinion gear 102 (which is less than the height of the rack 100) remains engaged with the rack regardless of whether the handle is pulled out or is pushed in. The pinion gasket 110 in the collar 111 surrounding the pinion shaft 108 (and the engaging tabs 112 in the retracted position) provides a water resistant seal and enough friction to prevent the pinion shaft from falling out when the battery system 40 is manipulated.

A contact switch 118 (seen in FIG. 6) operationally disengages from a protrusion 120 on the carriage top cover 106 with the connector carriage 52 in the extended position. When engaged (with the carriage in the retracted position) the micro switch de-energizes the entire battery, including the main power connector 76, the USB output, and the charger input circuits on the battery system PCB.

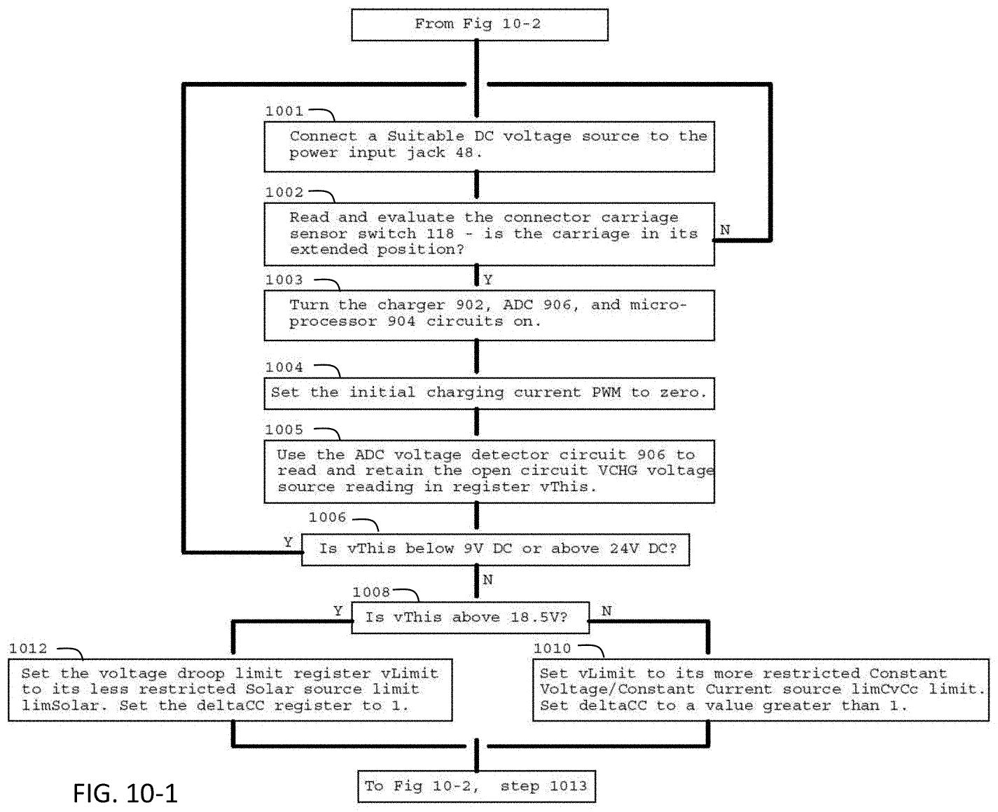

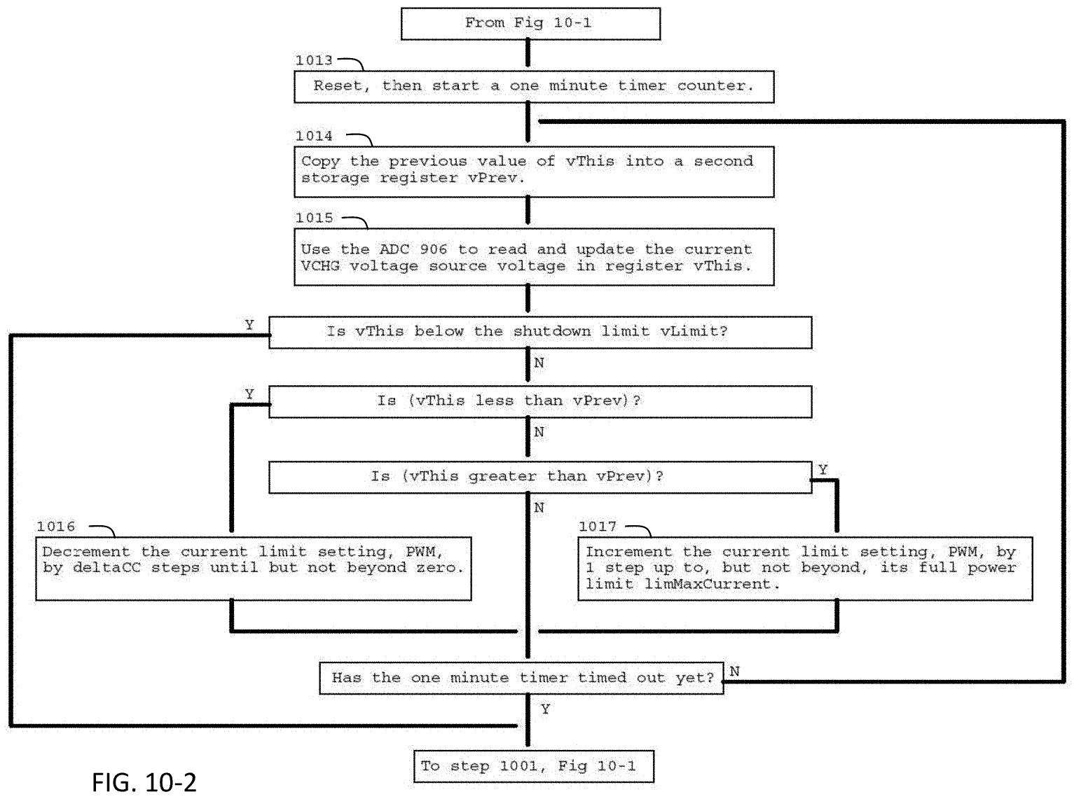

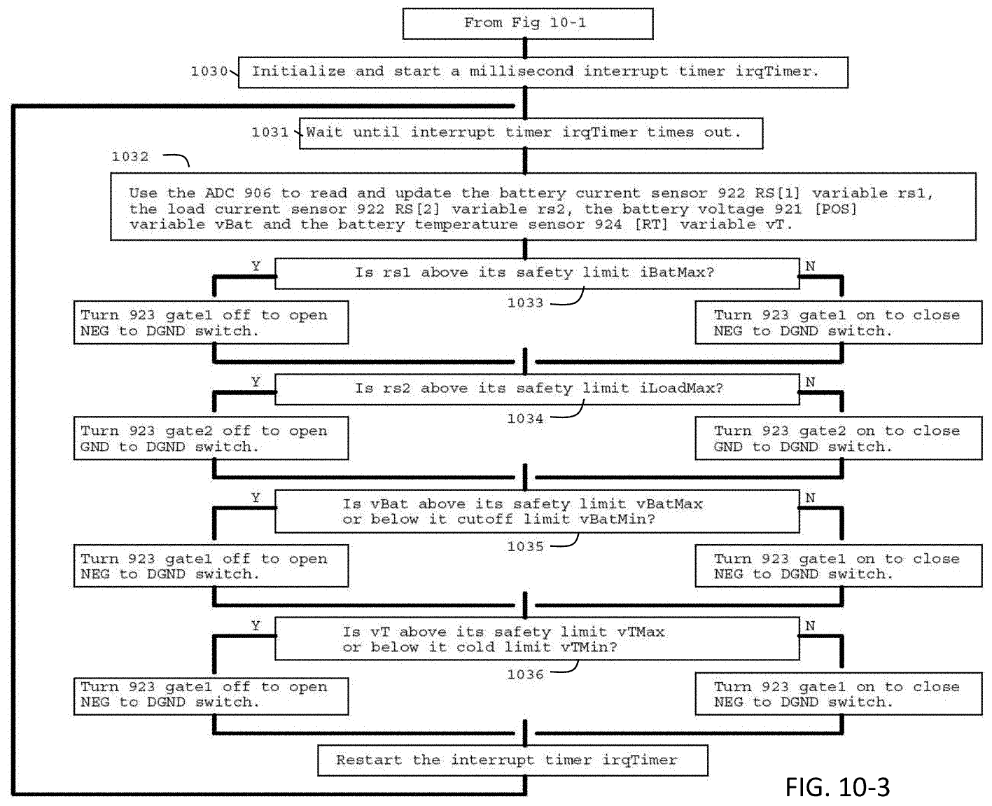

As previously described, a universal power charger input jack 48 is provided for the battery assembly 40. The battery charger controller portion of the of the PCPCB 70 employs a boost converter 902 as shown in FIG. 9 which, for the exemplary implementation, is based upon the TI LM5022 boost converter topology. A microprocessor based enhancement described with respect to FIG. 10 allows the boost converter's standard maximum current control circuitry to be over-ridden by a microprocessor 904 based upon the observed input voltage measured by a voltage sensor 906 and subsequent behavior of the input voltage under load.

Any form of DC source that can provide input voltages in the range from 9 VDC to 24 VDC may be connected to the universal power charger input jack 48, step 1001. The four primary example sources are a stiff, fixed voltage source (example: car nominal 12V power port), a current limiting DC voltage source (examples: wall plug power supply or bench power supply), a current limiting DC source (example: solar cell array), or a raw half rectified AC source (example: simple 50/60 Hz mains transformer).

The microprocessor initially reads the connector carriage sensor switch 118 to determine if the carriage is in the extended position, step 1002, and, if so, a charger 902, analog to digital converter (ADC) included in voltage detection circuit 906 and the microprocessor 904 circuits are turned on, step 1003. The initial charging current PWM is set to zero, step 1004. The ADC voltage detector circuit 906 is read to determine the open circuit VCHG voltage source and stores that value in a register, step 1005. The microprocessor ignores DC voltages below 9 VDC or over 24 VDC and returns to step 1001. When the microprocessor detects a voltage between 9 VDC and 24 VDC, step 1006, internal status flags are set based upon the measured value, step 1008. If the voltage is below 18.5V when first measured (at zero current load), the microprocessor assumes a current limited constant voltage source, step 1010. If the voltage is above that level, the microprocessor assumes the source is a constant current source (i.e. solar source), step 1012. These initial assumptions will be overridden if the subsequent behavior is inconsistent with the first guess.

Once the initial setup phase is completed, the microprocessor resets then starts a one minute timer counter, step 1013. A previous value of VCHG voltage source voltage is stored, step 1014, and the ADC reads and updates the VCHG voltage source voltage value, step 1015. If the voltage is less than a shutdown limit the cycle returns to step 1001. If not, a determination is made if the voltage is less than the previous stored voltage and, if so, reduces the current limit setting PWM by a predetermined decrement, step 1016. A determination is then made if the one minute timer counter has timed out and, if not, returns to step 1014. If so, the cycle returns to step 1001. If the determination that the voltage is less than the previous stored voltage is no, a determination is made if the voltage is greater than the previous stored voltage. If so, the current limit setting PWM is then incremented to increase the current drawn from the source but not more than the maximum limit that the boost converter allows, step 1017 (this is set at the factory and based upon the battery cell amp-hr rating). As the current increases, the voltage at the external power source will remain almost constant, and then begin to droop. This method provides a determination of the source type. If the source has a straightforward current overload limit, the voltage will drop abruptly. If the source has a soft (fold back) current limit, the voltage will drop more slowly. Either way, the voltage drops, and the microprocessor determines the source current limit has been exceeded. The microprocessor reduces the requested current by a few steps, and repeats observation. Once the source current limit has been reached, the microprocessor stops dithering and stays at the calculated operating point for approximately 1 minute after which it repeats the process until the battery pack 44 eventually reaches its full charge voltage of 38.6V (which is also dependent upon battery cell selected, and set at the factory). Thereafter, the battery is effectively trickle charged until the external source is removed.

A selected solar source will output a voltage near 20V and that voltage will drop as more current is demanded by the microprocessor. However, the solar cells voltage/current behavior is different from the other sources listed in that it has a very soft characteristic, i.e., the voltage drops much more for a given increase in load. The microprocessor therefore uses a more relaxed criterion for determining when and if it needs to limit the solar source load. The operating system set point also changes with solar flux, which can change within the one-minute sampling interval. If the operating point changes significantly, the microprocessor terminates the current interval and begins a new dynamic control interval.

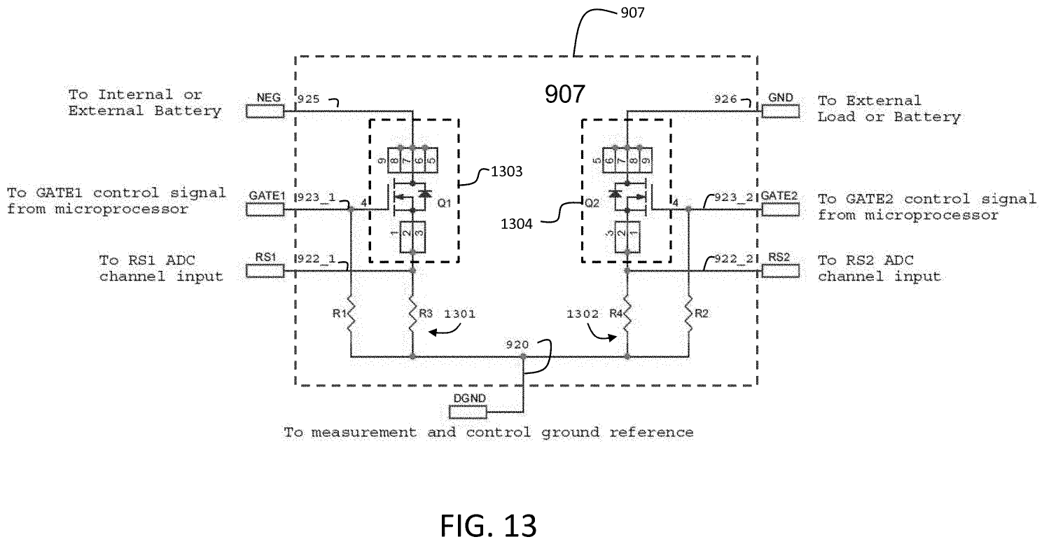

A symmetrical battery protection circuit 907 (shown in FIG. 9, FIG. 13, and described in FIG. 10-3) employs a pair of NFET power switch circuits 1303 and 1304 configured with the NFET sources (nodes 922_1 and 922_2) respectively connected in series to one end of a pair of sense resistors 1301 and 1302. The common connection point between the two sense resistors, node 920 (DGND), then becomes the electrical ground reference for the microprocessor 904 measurement and protection scheme. The microprocessor employs the analog-to-digital (ADC) voltage detection circuit 906 to measure the voltage across the two sense resistors with respect to the DGND node and protects against overcharge or overdischarge (overload) currents flowing in either direction into or out of the two power terminals 925 (NEG) and 926 (GND) by controlling the gate voltages 923 of the NFET switches using digital control methods to turn the NFET switches completely on or off, or an analog control method to cause the NFET switches to function as variable current limiting resistors (by linearly adjusting the NFET gate voltages 923). The overall topology of the battery protection circuit assumes a battery is connected between the common node 921 (POS) and node 925 (NEG) and a load is connected between POS and node 926 (GND). However, the symmetry of the circuit 907 allows connection of another battery of indeterminate state of charge between POS and GND, thereby placing both batteries in parallel. The analog control method is then used to evenly balance the total charge of both batteries so they can be charged together. This eliminates the requirement for both batteries to have independent built in charge control circuits. Additionally, the PCPCB is always powered via the NFET body diodes (shown in the schematic FIG. 13) regardless of whether the NFETs are on or off, allowing the control circuit to always be active (in sleep mode usually) even when the system is “off”.

The microprocessor 904 also protects against battery and electronics temperature extremes and battery voltage limits by measuring the battery voltage 921 and battery temperature sensor 924 and switching one or both NFET switches off until the measurements return to within their normal operating limits.

As seen in FIG. 10-3, a periodic interrupt process 1031 is first initialized 1030 and then used to measure all protection related variables 1032. These includes the battery voltage vBat, battery temperature vT, and the magnitude and direction of battery and load currents 922 flowing across the sense resistors 1301 and 1302 (variables rs1 and rs2). The measured sense resistor voltages may be negative with respect to 920 DGND. The microprocessor 904 with ADC circuit 906 is capable of accurately reading these small negative voltages as long as they remain below the ADC 904 input channel protection diode drop, approximately negative 0.3V. A negative voltage implies current flowing from 920 DGND into either 926 GND or NEG, and a positive voltage implies current flowing out of DGND or NEG.

External current flows from NEG to GND under normal charging conditions and vice versa during normal load conditions. However, the connection of an external battery between POS and GND will cause the overall current flow direction to reverse if that battery is at a higher state of charge than the internal battery connected between POS and NEG. This is why it is necessary to use the analog control method described above to reduce this external charging current to within safe limits.

Returning to FIG. 10-3, the measured variables are then compared to their corresponding limit values (steps 1033 to 1036) and the corresponding control gates 923 are then used to restore the corresponding measured values within their operating limits using the digital or analog control methods described earlier.

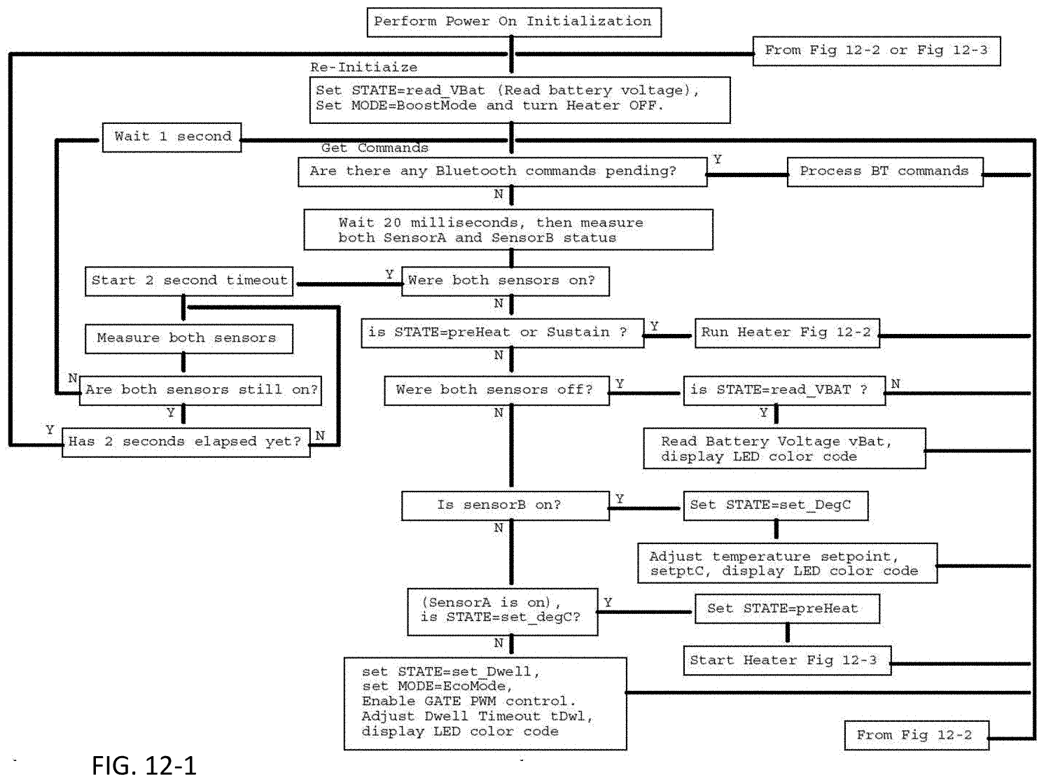

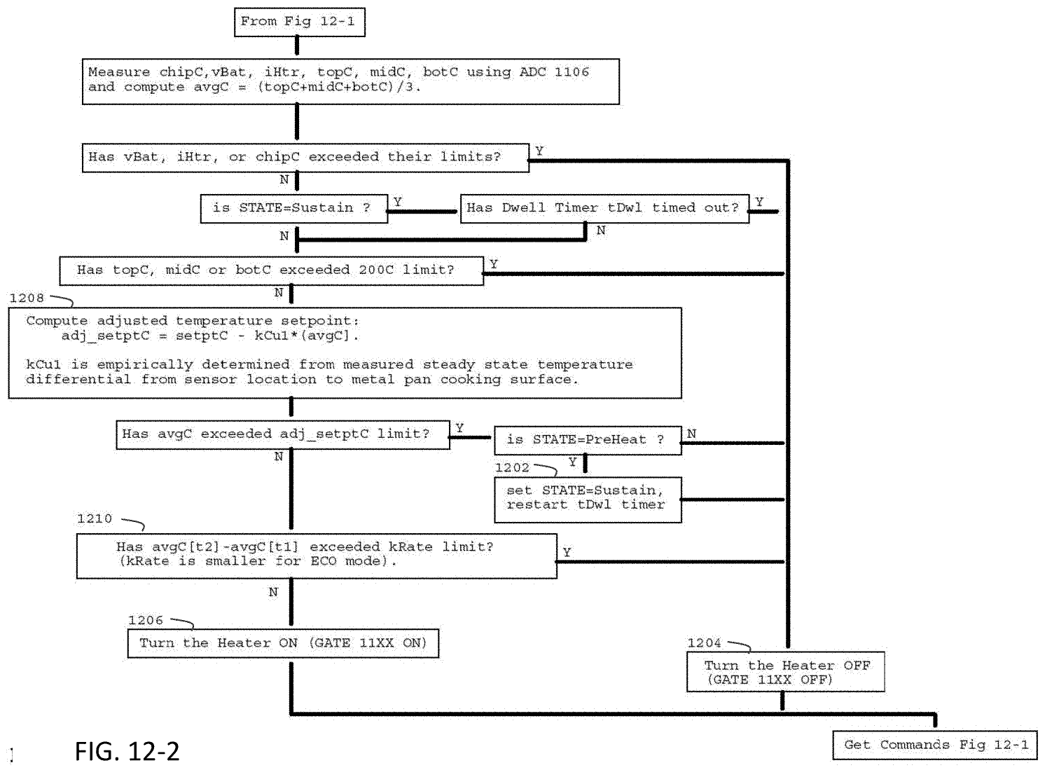

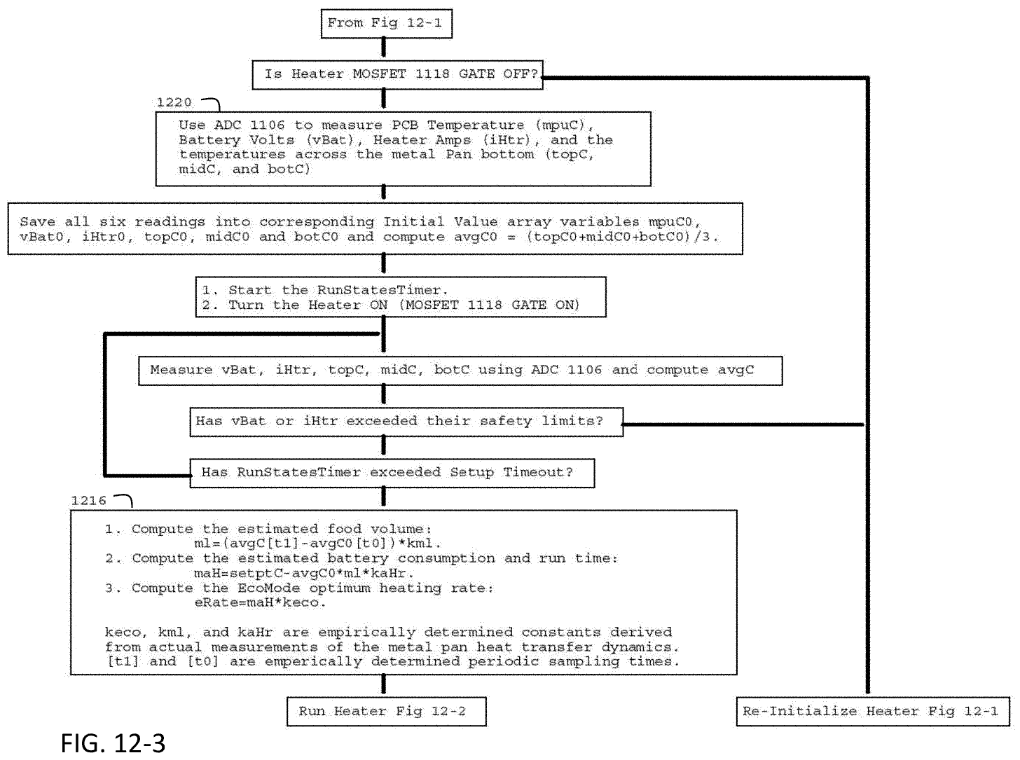

As seen in FIG. 11 and described with respect to FIG. 12 the foil heater is entirely controlled by a second microprocessor 1102 on the heater control PCB 72 that receives power from the connector 74 from the battery system 40. A microprocessor power supply 1104 steps down voltage for the second microprocessor 1102. The second microprocessor measures the voltages and current flowing out of the power port 58 and the temperatures of the metal pan using up to three thermistors 122 spaced diagonally across the bottom of the pan. The second microprocessor 1102 also measures the ambient temperature at the microprocessor chip with voltage detectors 1106. The second microprocessor employs a first state machine 1110 for heater setup and a second state machine 1112 for heater operation. A tri-color LED controller 1114 provides signaling output to a RGB LED 1116 located inside the well 25 in the gasket 22 as previously described. A MOSFET switch 1118 provides full control of current to the foil heater 85.

The second microprocessor employs two capacitive type control sensors 33 and 35 mounted to the heater control PCB 72, as previously described, that are used to set the target food temperature, the rate at which the heater power will be increased, and the dwell time once the target temperature has been reached before completely shutting down the heaters through the first state machine as shown in FIG. 12-1. Once the initial setup is completed, the buttons are then used to start the heater cycle and to manually stop (reset) the cycle. Alternatively, a BlueTooth™ controller 1113 may be employed for input. The heater control PCB 72 contains an integral Bluetooth remote control module 1108 capable of accessing the second microprocessor measurements and setting the second microprocessor operating parameters. This extends the foil heater functionality to the full processing power of modern cell phone operating systems. However, given the intended application (outdoors), the system will always require the manual controls described above since presence of an operating cell phone cannot be assumed.

The second microprocessor implements two processing modules in the second state machine 1112, the eco mode and the boost mode, as shown in FIG. 12-2.

The boost mode simply provides power to the foil heater and measures all pan thermistors 122 and the voltage and load current of the battery pack 44. The boost mode enters a dwell phase once the average thermistor readings reaches the target temperature, step 1202. The heater is also turned off if any thermistor exceeds 200C or the battery pack condition is below its shutdown limits step 1204. Assuming the battery pack is within acceptable limits, the heaters are turned back on once the average thermistors readings have dropped a few degrees, step 1206.

The eco mode measures all pan thermistors and the battery condition, and computes a temperature set point, step 1208. It will enter the dwell phase once the average thermistor reading reaches a target temperature, step 1210. It will increase heater power if the average temperature is below the target temperature and decrease the heater power if the average temperature is above target temperature. The limits are chosen to optimize the thermal performance of the overall foil heater system and are based upon observed foil heater thermal performance under varying conditions and the initial ambient temperature as shown in FIG. 12-3. The second microprocessor detects ambient temperature by measuring its chip temperature, and the average pan temperature by measuring all pan thermistors, step 1220. The second microprocessor can also estimate the volume of food in the metal pan, by observing the rate of change of the pan thermistors shortly into the heater cycle, step 1216. All of these measurements are used in the eco mode to optimize the conversion of the battery energy used to heat the food, and to estimate the battery energy requirement to meet the intended target temperature (and the corresponding time to reach the target temperature).

The overall objective is to increase the total cooking capacity and duration of heated food that can be achieved with a fresh battery as much as physically possible. Eco mode trades heating time to achieve this objective. Boost mode minimizes heating time at the expense of greater battery consumption.

In a specific example of implementation of the methods described for the heater controller microprocessor is described below with reference to the flow charts in FIGS. 12-1 through 12-3.

Beginning with the Flow chart in FIG. 12-1 heater control commences with a Perform Power On Initialization.

A Re-initialize sequence is performed by Set STATE=read_VBat (Read battery voltage), Set MODE=BoostMode and turn Heater OFF.

Get Commands then determines what the user is commanding. Are there any Bluetooth (BT) commands pending? If yes process BT commands and return to Get Commands. If no Wait 20 milliseconds, then measure both SensorA and SensorB status. Were both sensors on? If not is STATE=preHeat or Sustain ? if so run heater. If both sensors were on Start 2 second timeout Measure both sensors Are both sensors still on? If not wait 1 second and then go to Get Commands If yes has 2 seconds elapsed yet? If not return to measure both sensors If yes return to re-initialize If both sensors were off and STATE=read VBAT then Read Battery Voltage vBat, display LED color code and return to Get Commands If only sensor B was on Set STATE=set_DegC, Adjust temperature setpoint, setptC, and display LED color code and then return to Get Commands. If only sensor A was on is STATE=set_degC? If so Set STATE=preHeat and Start Heater FIG. 12-3 and set STATE=set_Dwell, set MODE=EcoMode, Enable GATE PWM control. Adjust Dwell Timeout tDwl, display LED color code

If the Get Commands steps determine transfer to FIG. 12-2 Heater Run then Measure chipC,vBat, iHtr, topC, midC, botC using ADC 1106 and compute avgC=(topC+midC+botC)/3. Has vBat, iHtr, or chipC exceeded their limits? If so Turn the Heater OFF (GATE 11XX OFF) and go to Get Commands. If not, is STATE=Sustain ? If so Has Dwell Timer tDwl timed out? If so Turn the Heater OFF (GATE 11XX OFF) and go to Get Commands. If not has topC, midC or botC exceeded 200C limit? If so Turn the Heater OFF (GATE 11XX OFF) and go to get commands, if not Compute adjusted temperature setpoint: adj_setptC=setptC—kCul*(avgC]. kCul is empirically determined from measured steady state temperature differential from sensor location to metal pan cooking surface.

Has avgC exceeded adj_setptC limit? If so is STATE=PreHeat ? if not Turn the Heater OFF (GATE 11XX OFF) and go to Get Commands. If so set STATE=Sustain, restart tDwl timer Has avgC[t2]-avgC[t1] exceeded kRate limit? (kRate is smaller for ECO mode). If so, turn heater Off and go to Get Commands. If not Turn the Heater ON (GATE 11XX ON)and then go to Get Commands.

If the Get Commands sequence determines a heater startup is needed then FIG. 12-3 text heater startup is employed Is Heater MOSFET 1118 GATE OFF? If so go to re-initialize heater Use ADC 1106 to measure PCB Temperature (mpuC), Battery Volts (vBat), Heater Amps (iHtr), and the temperatures across the metal Pan bottom (topC, midC, and botC). Save all six readings into corresponding Initial Value array variables mpuCO,vBatO, iHtrO, topCO₃ midC0 and botCO and compute avgC0=(topC0+midC0+botC0)/3.

### 1 Start the RunStatesTimer.

2. Turn the Heater ON (MOSFET 1118 GATE ON) First Measure vBat, iHtr, topC, midC, botC using ADC 1106 and compute avgC If vBat or iHtr exceeded their safety limits return to check if heater MOSFET 1118 gate is off.

If RunStatesTimer exceeded Setup Timeout then return to first measure, If not

1. Compute the estimated food volume: m1=(avgC [t1]-avgC0 [t0])*kml.

2. Compute the estimated battery consumption and run time:
maH=setptC-avgC0*ml*kaHr. 3. Compute the EcoMode optimum heating rate:
eRate=maH*keco. keco, kml, and kaHr are empirically determined constants derived from actual measurements of the metal pan heat transfer dynamics. [tl] and [tO] are empirically determined periodic sampling times.

Then go to Run Heater FIG. 12-2.

Referring again to FIG. 9, FIG. 10-3 and FIG. 13, the battery system 40 is fully protected by the battery management protection circuit previously described.

Additional protection is provided by the recessed contacts in the Anderson PowerPole connectors employed in the exemplary embodiment, the retraction of the entire connector within the battery, the sliding power port door, and the total shutdown of the power port in the retracted position.

The disclosed implementations provide benefits including almost error proof connection (cannot be connected backwards), extremely good contact wiping ability, and the use of a parallel battery system/PHA configuration which maximizes backpack storage options and stabilizes the operating fry pan against wind gusts (an improvement over having the heating source below the vessel which then must mount above it and use either tripod legs or the fry pan windshield to hold the pan). The standard arrangement puts the center of gravity much higher up than the present side mount scheme, and thus, it is less stable. The ability to merely physically separate the PHA and battery system provides an added safety feature of instant off with disconnection of the connector. The battery assembly is configured with a cylindrical form factor to fit a standard vehicle cup holder. The non-operating mode provides a method to position the battery upside down in a cup holder so the battery assembly can optionally be recharged by plugging its power input jack into a vehicle power port source The battery assembly can optionally remain held in the holder until the battery fully recharges.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An electronic fry pan comprising:
a pan and heater system (PHA) having
a pan base;
a pan concentrically received in the pan base,
a foil heater assembly adhered to a bottom of the metal pan;
a heater control printed circuit board (PCB) carried in the pan base and operationally connected to the foil heater;
a battery assembly having
a substantially cylindrical shell;
a battery pack carried within the cylindrical shell;
a power controller printed circuit board (PCB) carried in the cylindrical shell and operationally connected to the battery pack;
a connector carriage, extendable from the battery assembly proximate a bottom surface of the cylindrical shell and adapted to be engaged between the battery assembly and the PHA in an operating mode, the connector carriage removably extending through an aperture in the cylindrical shell of the battery assembly and received through a power port in the pan base, said power port proximate a bottom surface of the pan base and aligned with the aperture whereby the bottom surface of the pan base and bottom surface of the cylindrical shell are in planar alignment;
a first contact set of a connector, said first contact set carried by and operationally connected to the heater control PCB;
a second contact set of the connector, said second contact set carried by the connector carriage and operationally connected to the power controller printed circuit board.

2. The electronic fry pan as defined in claim 1 wherein the PHA and battery system are separable in a non-operating mode and said connector carriage is retractable into the cylindrical shell.

3. The electronic fry pan as defined in claim 2 wherein the connector carriage further comprises:
a connector carrier attached to a translation body, the translation body having a rack which is operatively engaged by a pinion;
a rotating handle extending from the pinion;
a shaft translatably carried in a pinion gasket received in a collar in the second cylindrical shell, the shaft translatable axially in the pinion gasket between a first engaged position of the pinon and rack and a second locked position, in the locked position for the non-operating mode with the connector carriage retracted, tabs on the handle are received in retracted lock slots in the translation body, locking the connector carriage in the retracted position and the handle is restrained from rotation, the handle axially translatable outward through pinion gasket to withdraw the tabs from the retracted lock slots allowing rotation of handle and pinion to drive the rack to extend the connector carriage, upon reaching the extended position, the handle is axially translatable inward engaging the tabs in extended lock slots thereby locking the connector carriage in the extended position to allow interconnection between the battery assembly and PHA for the operating mode.

4. The electronic fry pan as defined in claim 3, further comprising;
a USB connector carried in the cylindrical shell and operationally connectable to the battery pack;
a universal charger input carried in the cylindrical shell and operationally connectable to the battery pack;
a switch operationally contacting the connector carrier in the retracted position and adapted to disable all externally accessible electrical connections

5. The electronic fry pan as defined in claim 2 wherein the pan is stamped sheet metal.

6. The electronic fry pan as defined in claim 5 wherein a bottom of the pan is less than 1.6 mm thick.

7. The electronic fry pan as defined in claim 1 wherein the foil heater comprises:
an etched foil layer mounted on a silicon rubber substrate with a silicon rubber top layer laminated over the foil layer and sealed to the substrate and further comprising:
a ceramic paper insulator carried in a cavity between the pan and the pan base.

8. The electronic fry pan as defined in claim 1 wherein the pan has a rim received on a flange of the pan base with an intermediate gasket between the rim and top flange and a top frame engaged to the flange using a plurality of screws to engage the rim of the pan against the gasket sealing pan to the pan base.

9. The electronic fry pan as defined in claim 8 further comprising a cover received on the top frame.

10. The electronic fry pan as defined in claim 1 wherein power controller PCB incorporates a protection circuit comprising:
a pair of NFET power switch circuits configured with NFET sources connected in series to one end of a pair of sense resistors, wherein the common connection point between the two sense resistors becomes an electrical ground reference, and a first power terminal and second power terminal are controlled by gate voltages input to the NFET switch circuits, said NFET switch circuits configured to use digital control methods to turn the NFET switches completely on or off, or an analog control method to cause the NFET switches to function as variable current limiting resistors by linear adjustment of the NFET gate voltages.

11. The electronic fry pan as defined in claim 10 wherein the heater control PCT further incorporates:
a microprocessor; and,
an analog to digital (ADC) voltage detection circuit;
wherein the microprocessor receives an input from the analog-to-digital (ADC) voltage detection circuit of voltage across the two sense resistors with respect to the ground reference and the microprocessor is configured to protect against overcharge or overdischarge (overload) currents flowing in either direction into or out of the NFET power switch circuits.

12. The electronic fry pan as defined in claim 11 wherein the battery pack is connected between the common node and the first power terminal and the second contact set of the connector is connected between second power terminal and the common node.

13. The electronic fry pan as defined in claim 12 wherein the power controller PCB is powered via body diodes of the NFET power switch circuits regardless of whether the NFETs are on or off, thereby allowing the control circuit to always be active even when the NFET switch circuits are “off”.

14. A method for heating of a PHA having a pan comprising:
receiving an input for a desired heating mode and target temperature;
if the desired heating mode is a boost mode
providing full available power to a foil heater mounted to a bottom of the pan;
measuring battery pack condition;
measuring temperatures of a first thermistor located proximate a first end of a diagonal of the metal heating area, a second thermistor located centrally on the metal heating area and a third thermistor located proximate a second end of the diagonal of the metal heating area;
entering a dwell phase when average thermistor readings reaches the target temperature;
removing power from the foil heater;
measuring temperatures of the all thermistors and, if battery pack condition is within acceptable limits, providing power to the foil heater upon measured decrease in average temperature of all thermistors;
repeating the dwell phase.

15. The method of claim 14 further comprising:
if the desired heating mode is an eco mode
measuring initial temperatures of the all thermistors,
measuring battery pack condition,
computing a target temperature and estimated power to reach the target temperature based on battery pack condition;
starting a heating cycle and providing the estimated power to the foil heater;
estimating the amount of thermal loading of the food volume in the metal heating area by measuring the average temperature of the thermistors after a predetermined time in the heating cycle;
computing a revised temperature set point and revised estimated power based on the measured thermal loading;
resuming the heating cycle by providing the revised estimated power to the foil heater;
entering a dwell phase when the average thermistor readings reaches the temperature;
increasing heater power if the average thermistor readings are below the temperature set point, and decreasing the heater power if the average thermistor readings are above the temperature set point.

16. A method for battery charging with a universal power charger input comprising:
connecting a source to a universal charger input jack;
setting a charging current PWM to zero;
determining an open circuit VCHG voltage source voltage and storing that value;
resetting then starting an interval timer counter;
storing a previous value of VCHG voltage source voltage reading and updating the VCGH voltage source voltage value;
if the voltage is not less than a shutdown limit the cycle determining if the voltage is less than the previous stored voltage and, if so, reducing the current limit setting PWM by a predetermined decrement;
determining if the interval timer counter has timed out and, if not, returning to storing a previous value of VCHG voltage source voltage;
if so, returning to setting a charging current PWM to zero;
if the determination is that the voltage is not less than the previous stored voltage determining if the voltage is greater than the previous stored voltage;
if so, incrementally increasing the current limit setting PWM increase the current drawn from the source but not more than a maximum limit;
determining if the interval timer counter has timed out and, if not, returning to storing a previous value of VCHG voltage source voltage;
if so, returning to setting a charging current PWM to zero.
